(19) United States
(12) Patent Application Publication
(10) Pub. No.: US 2024/0296572 A1
(43) Pub. Date: Sep. 5, 2024

(54) Systems and Methods for Image Registration and Imaging Device Calibration

(71) Applicant: Sportlogiq Inc., Montreal (CA)

(72) Inventors: Mehrsan JAVAN ROSHTKHARI, Beaconsfield (CA); Feng SHI, Ottawa (CA); Paul Christopher MARCHWICA, Kitchener (CA); Juan Camilo GAMBOA HIGUERA, Montreal (CA); Christopher Michael JAMIESON, Waterloo (CA); Parthipan SIVA, Waterloo (CA)

(73) Assignee: Sportlogiq Inc., Montreal (CA)

(21) Appl. No.: 18/663,894

(22) Filed: May 14, 2024

Related U.S. Application Data
(63) Continuation of application No. PCT/CA2021/051848, filed on Dec. 20, 2021.

(51) Int. Cl. G06T 7/30; G06T 7/80

(52) U.S. Cl. CPC G06T 7/30; G06T 7/80; G06T 2207/30228

(57) ABSTRACT

A system and method for registering images to each other or registering images to templates to generate geometric or nonlinear registration transformation mappings is disclosed. The method includes obtaining a first image from an imaging device, and obtaining either a reference image from the imaging device, or a template, comprising a partial or full representation of contents of the first image. The reference image or the template is in a second modality, and the first image is in a first modality. At least one mapping function is applied to one of the reference image or template, or both the first image and the reference image or template by mapping pixel data of the template or reference image to the first image to generate an estimation of a parametric registration transformation. Output data comprising one or more parameters of the parametric registration transformation is provided.

### CROSS-REFERENCE TO RELATED APPLICATION(S)

This application is a Continuation of PCT Application No. PCT/CA2021/051848 filed on Dec. 20, 2021, the contents of which are incorporated herein by reference in their entirety.

### TECHNICAL FIELD

The following generally relates to systems and methods for processing images and videos, more specifically self-learning methods for shape matching and calibrating imaging devices.

### DESCRIPTION OF THE RELATED ART

Image registration and geometric transformation estimation, in the form of homography estimation or camera parameter estimation, is a fundamental computer vision problem with applications in image mosaicking, simultaneous localization and mapping, camera calibration, and sports field registration.

In prior attempts, most of the methods for image registrations rely on either using a set of predefined key points to align two images or establishing an image point correspondence between images having the same modality. (e.g., modalities such as natural visible light RGB images, Brown and Lowe (2003), and simultaneous localization and mapping, Mur-Artal and Tardós (2017)).

Single-modality image registration methods automatically detect the key points in the two images being aligned using either (1) standard image feature extractors, or (2) convolutional neural networks. The key points are used to establish a form of point correspondence between the two images, and subsequently geometric transformation parameters or the homography transformation between the two is derived.

Conventional methods for image registration either use dense or sparse feature based methods, wherein dominant image features are used to establish point correspondences between images to generate a registration function. The use of convolutional neural networks (CNNs) for homography estimation removes the need of establishing a point correspondence between the images in order to estimate homography transformation, however CNNs require training data as they follow supervised learning methods. Training data usually includes a set of images wherein the pairwise homography between each two pairs of images is known in single-modality homography estimation, Detone et al. (2016).

Conventional image registration techniques are unable to establish the linear and nonlinear geometric transformation between images that are in different modalities. Some techniques such as mutual information maximization can align multi-modal images, Viola et al. (1997), however they require a set of pre-defined effective image features to estimate mutual information.

In prior attempts, cross-modality registration is applied on sports broadcast images in the form of homography estimation or camera calibration using either local feature matching techniques or a key-frame seeking over a video. These methods typically assume the parameters to be estimated are initialized so that the transformation is close to the identity, re-using the solution from previous frames in subsequent video frames.

### SUMMARY

In one aspect, a method for registering images to each other or registering images to templates to generate geometric or nonlinear registration transformation mappings is disclosed. The method includes obtaining a first image from an imaging device, wherein the first image is in a first modality, and obtaining either a reference image from the imaging device, or a template. The reference image or the template includes a partial or full representation of contents of the first image, and the reference image or the template is in a second modality. The method includes applying at least one mapping function to one of the reference image or template, or both the first image and the reference image or template by mapping pixel data of the template or reference image to the first image to generate an estimation of a parametric registration transformation. The method includes providing output data comprising one or more parameters of the parametric registration transformation.

In another aspect, a computer readable medium storing computer executable instructions for performing the method of the aforementioned method aspect is disclosed.

In another aspect, a device comprising a processor, an input interface for obtaining images from an imaging device, and a memory, the memory comprising computer executable instructions that when executed by the processor cause the device to perform the aforementioned method aspect is disclosed.

In contrast to existing methods, in example embodiments the following discloses a method for cross-modality image registration with applications for homography estimation and camera parameter estimation. In cross-modality registration, the two images to be registered together do not represent the same type of information. For example, one image can be a three channel red green blue (RGB) image obtained from a visible light imaging device, and the other image can be a drawing of the same scene wherein only the contours of the objects are identified as a binary pattern. Other examples include registering images to synthetic templates, segmented images, edge or road maps, etc.

The disclosed methods and systems for cross modality image registration with applications for camera calibration do not require training data, or a set of previously labeled images, or use pairs of images with known geometric transformations between them, in stark contrast to the prior art. Instead, a self-supervised learning method is disclosed which teaches itself from unlabeled data to estimate the geometric transformations for image registration and camera calibration.

In example embodiments, the disclosed method can be advantageous in applications or scenarios where texture or color information is not available, as in the case of edge templates.

### BRIEF DESCRIPTION OF THE DRAWINGS

Embodiments will now be described by way of example only with reference to the appended drawings wherein:

FIG. 1 depicts a schematic block diagram of a module or device for image registration.

FIG. 2A is a block diagram of a system for generating a registration parameter estimator using a learning mechanism, which is then employed to do image registration.

FIG. 2B is a block diagram of a system for generating a registration parameter estimator in an alternative configuration.

FIG. 3 is a schematic flow diagram showing an example of image registration executed using the system shown in FIG. 1.

FIG. 4 is a schematic diagram showing an example of image registration executed using artificial neural networks for registration parameter estimator in the system shown in FIG. 1.

FIG. 5 is a schematic flow diagram showing an example of self-learning mechanism for image registration executed using the system shown in FIG. 2A.

FIG. 6 is an example of registering sports images to a template of the sport field for soccer.

### DETAILED DESCRIPTION

In this disclosure, the term register, when used in relation to two different data sets representing captured images (hereinafter themselves referred to as images for simplicity), shall be used to denote the process whereby the different images are mapped or fitted onto one coordinate system. Registration can mean that one image is fitted to a second image's coordinate system, or vice versa, or that both images are fitted to a coordinate system not initially related to either image. Various processes of registration are contemplated, and this introductory paragraph is understood as not limiting the scope of registration techniques contemplated by this disclosure.

The terms “image” and “frame”, when used in this disclosure, are intended to interchangeably denote data representing the information captured by an imaging device directed towards a scene or location (e.g., a sports field location wherein a sport playing scene may be unfolding). For clarity, the terms “scene” or “location” refer to an observation as would be interpreted by human eyes, whereas the terms image or frame also refer to a digitized representation of the observation as captured by the imaging device. The terms image and frame may be used interchangeably, and the terms scene or location or sport field are also used interchangeably.

The following relates to self-supervised learning for self-camera calibration, planar homography transformation estimation, image registration, and camera pose estimation. The disclosed self-supervised learning at least in part teaches itself to align an observed image to another image which may be in a different modality. Applications which can benefit from the disclosure can include, for example, camera calibration and sports field registrations. Without using a set of labeled data (e.g., images with known camera parameters or pairs of images with known registration parameters), alternatively referred to as training data, the disclosed methods learn to generate accurate registration parameters from images which are captured with unknown camera parameters or where the pairwise registration parameters are not provided as a part of the training data.

An exemplary embodiment describes the method for sports field registration as an exemplary application of the disclosed cross-modality image registration. The method directly estimates the geometric transformation, or homography, between a template of the sports field and a received image of the sport field, colloquially referred to in the alternative as a “frame” from a video of a broadcast feed of a sport event played on the sports field. The method can measure the misalignment error of the registration result and report how well the images are registered together. The method can estimate the actual size of the sports field from the image and adjust the temples to account for the true measurements, if the template of the sports field does not include correct information about the actual dimensions of the sports field shown in the received image. In example embodiments, the misalignment error and the size estimate can be generated simultaneously.

An exemplary embodiment described below includes registering broadcast videos of a sports match or game to sports field template. It can be appreciated that the system and methods described herein can also be used for other relevant applications such as simultaneous localization and mapping in robotics applications, camera pose estimation with respect to planar objects with known dimensions, aerial image to road map alignment, and image-to-image registration for biomedical imaging applications, to name a few.

The methods and systems described herein are configured to register an image to one of a template or another image using a registration parameter estimator. The registration parameter estimator can be learned or generated from arbitrary images of the same scene or different scenes, obtained from the same or different imaging devices, without the use of prior information about the calibration data of the imaging device that the images are obtained from. In an exemplary embodiment, the homography transformation and camera parameters are estimated for an image given a reference template by using the registration parameter estimator.

In one aspect, the system registers one image to another image, while in another aspect the method registers the image to a so-called reference template, wherein the reference template is a representation of one or more 3D objects or one or more 2D planes with known geometry in the scene, fully or partially visible in the image. In this disclosure, the term reference template can be used to denote 3D objects and/or 2D planes, image edge maps of the input image, or a 2D synthetic illustration of a sport field showing the lines and marks of the sports field.

The system applies a self-learning process on unlabeled data to learn the mapping function that can align an image (e.g., an input image) to a reference template, which is referred to as the registration parameter estimator. The registration parameter estimator can either be applied once to the input image or be used in an iterative process wherein for the first iteration the registration is applied on the input image, and the input image is transformed with the estimated registration parameters. In the next iteration, the resulting transformed image is considered to be a new input image, and registration is performed on the new input image. The process is repeated until the desired error or accuracy is achieved or a maximum number of iterations is performed.

The self-learning process to learn the registration parameter estimator can take advantage of training data, if available. In example embodiments, labeled data can be combined with unlabeled data to augment the training data set and the registration parameter estimator can be trained using a combination of both labeled and unlabeled data.

The following also discloses a method to measure the quality of the estimated registration parameters, as well as adjusting the reference template when the template dimensions are not accurately representing the shapes and objects in the scene. In an exemplary embodiment of the system, a single image from a sporting event broadcast video is registered to a template of the sports field, and because often the exact dimensions of the sports field are unknown beforehand, the template is adjusted based on the estimated registration error so that the input image is registered to a template with correct dimensions. This can result in automatically measuring the dimensions of the sports field solely based on the input image, without using any prior knowledge about the sports field.

The registration parameter estimator takes an input image and generates the relevant parameters for a transformation that aligns the input image to the reference template. In one aspect, the registration parameter estimator produces homography transformation parameters of six degrees of freedom camera parameters. In another aspect, the registration parameter estimator generates a sparse or dense pixel-to-pixel displacement between the image and the template, and then the geometric transformation is estimated from the pixel displacements. In yet another aspect, the registration parameter estimator generates at least four points on the reference template, corresponding to four arbitrarily chosen control points in the image, and thus, represent the homography transformation using four-point parameterization.

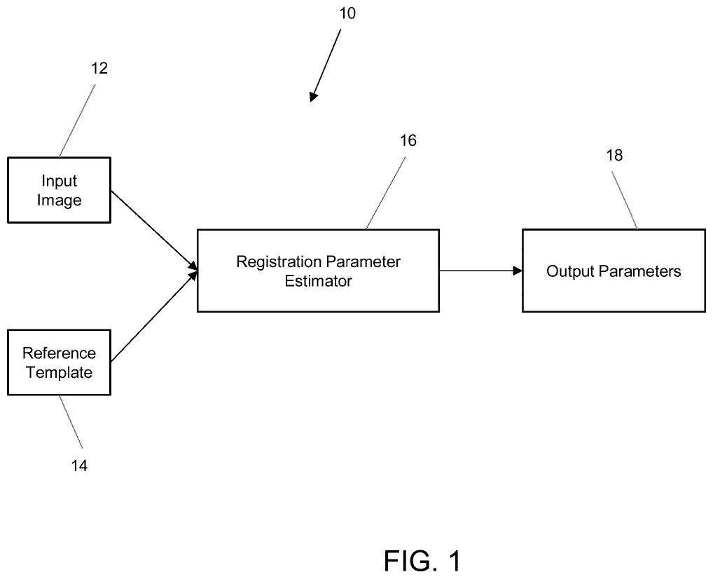

Turning to the figures, FIG. 1 depicts a schematic block diagram of a module, device or other computing system or component of a computer or computing system 10, for registering an input image 12 to a template 14.

The input image 12 can be a variety of types of data structures for capturing visual information observed by an imaging device, including true color images (e.g., a conventional RGB image), indexed images, binary images, etc.

Similarly, the template 14 can be a variety of types of data structures for capturing or representing visual information, including information about shapes and textures. For example, the template 14 can be an edge map of another natural image or any image such as a synthetic template map (e.g., a schematic representation of a location) such as a sports field template that captures shape information associated with image 12.

The template 14 can include visual information similar to or at least in part dissimilar to the visual information captured by the image 12. For example, both the template 14 and the image 12 can be images of the same a soccer field from the same perspective, or the image 12 and the template 14 can be dissimilar at least by virtue of capturing image information of the same location from different images, or capturing different subsets of the scene, etc. In further illustrative embodiments, the image 12 and the template 14 can include information in the same or different modalities. Additionally, the template 14 can be a 2D or 3D synthetic representation of some of the contents of the scene, showing the full scene or a part of the scene.

The registration parameter estimator 16 of the system 10 includes one or more function approximators. The registration parameter estimator (alternatively referred to as mapping function) 16 is applied to the input image 12 and the template 14 to generate output parameters 18. The output parameters 18 can be used for subsequent image registration transformations. In at least some example embodiment, the output parameters 18 are at least one of the following: linear and non-linear geometric transformation parameters, homography transformation parameters, camera parameters for an imaging device (not shown) which generated the input image, at least four control points either on the input image 12 or the template 14, wherein the control points are used to estimate a homography transformation between the input image 12 or the template 14 using four point parameterization.

In example embodiments, the output parameters 18 may contain some parameters measuring the misalignment error or the quality of the estimated registration parameters, or an adjustment to the template 14 when the template 14 does not align correctly with the input image due to error (e.g., noise in the process of generating the template 14 or the input image 12, etc.).

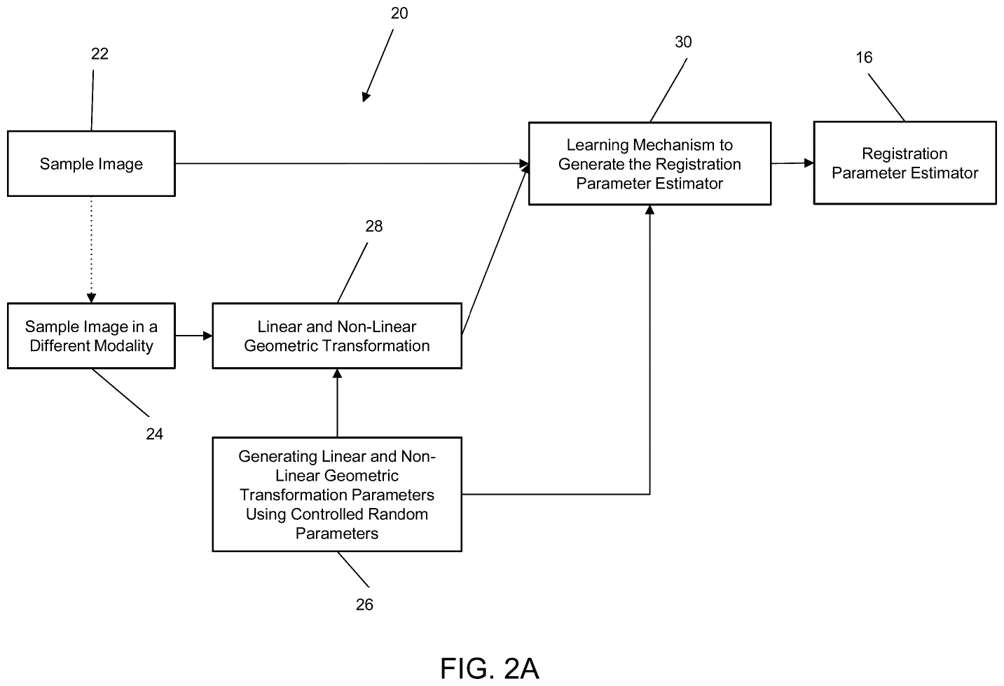

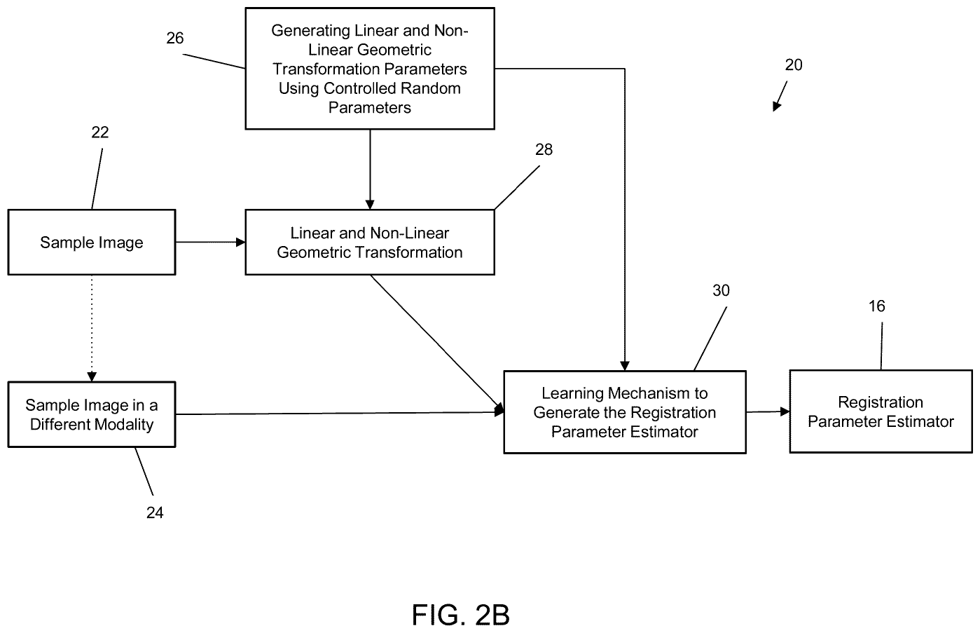

FIG. 2A depicts a schematic block diagram of a process 20 for generating the registration parameter estimator 16. The process 20 includes a self-learning mechanism which is applied on sample data to build a registration parameter estimator 16. In the shown embodiment, the self-learning mechanism takes as inputs a sample image 22 and a transformed version of the sample image 22, denoted by image 24. The image 24 can be an image in a different modality as compared to the image 22. For example, the sample image 22 can be a conventional RGB image and the image 24 can be an edge map of the image 22. In example embodiments, the process 20 includes generating the transformed image 24, for example, by implementing edge detection techniques to image 22.

The process 20 further includes generating ground truth data points to further construct the registration parameter estimator 16. For this purpose, a set of controlled random parameters 26 are generated, and then used to construct a ground truth linear or nonlinear geometric transformation 28, wherein the parametrization of the geometric transformation is known. The constructed ground truth geometric transformation 28 is applied to the image 24. Given the known parameters for the ground truth geometric transformation 28, a machine learning technique 30 can be applied to the pair of the sample image 22 and the transformed image 24, to estimate the parameters of the ground truth geometric transformation 28 by minimizing the loss function that measures the dissimilarity between the estimated geometric transformation 18 obtained from the registration parameter estimator 16 and the ground truth transformation 28. In the result, the machine learning technique 30 adapts the parameters of the registration parameter estimator 16 so that the registration parameter estimator 16 learns to output parameters that can be used to register the two images together, referred to as the training or learning process. Once the training process is completed, the output of the process 20 is a registration parameter estimator 16 that is capable of registering the two images notwithstanding that the two images are possibly in different modalities. In contrast to prior attempts, the process 20 does not require the use of training data sets, which is a standard practice in supervised machine learning techniques (e.g., the standard techniques include using a set of pairwise images with known geometric transformations to be used to train the learning mechanism 30). Instead, the training is done using a single image (e.g., the sample image 22) and a transformation of the single image (e.g., image 24).

FIG. 2B depicts a variation of the same process depicted in FIG. 2A, wherein the geometric transformation 28 is applied on the sample image 22 instead of the transformed image 24 (i.e., FIG. 2B shows the image 22 being registered to the coordinate system of image 24). The remaining steps of the process are the same as FIG. 2A.

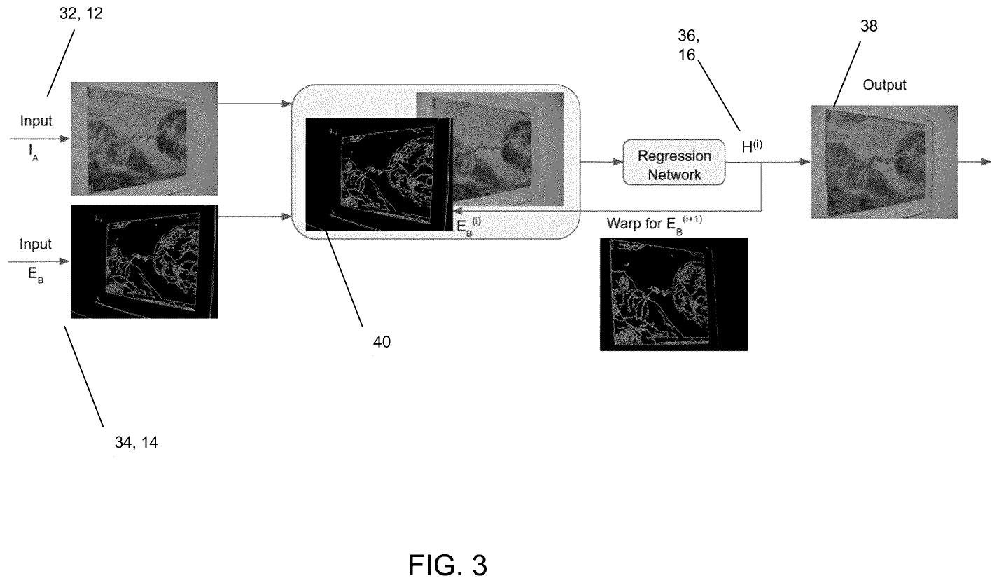

FIG. 3 illustrates cross-modality image registration between an input image 32 and an edge map 34 of the input image 32, in an iterative scheme to register the two. The registration parameter estimator is an artificial neural network, referred to as the regression network 36 that generates a four-point parameterization of images 32, 34 to establish homography 36 (also denoted by H⁽ⁱ⁾ in FIG. 3) between the two images. The term “network” is used here as a generic term for a function approximation method and should not be limited to artificial neural networks (NNs). A homography transform matrix between the cross-modality images 32 (also denoted by I_{A} in FIG. 3 for further clarity) and 34 (also denoted by E_{B} in FIG. 3 for further clarity) is iteratively estimated by stacking images 34 and images 32 as inputs into the regression network. At the i^{th} iteration the output homography, H⁽ⁱ⁾ is generated and then used to warp the image 34 part of the network input stack, for example, into the warped image 40. The output 38 shows the result of the output one or more parameters of the parametric registration transformation 36 being applied to the images 32, 34 to register the two. Note that image 34, similar to image 14, can be an edge map of another natural image or any image such as a synthetic template map or sports field template that captures the shape information of the input image 32. The interactive scheme can run for one iteration or for multiple iterations until a desired registration accuracy is achieved.

An exemplary embodiment illustrates how the registration parameter estimation works using artificial neural networks to estimate the image registration parameters, more specifically in terms of homography estimation between two images. More specifically, the image registration methodology presently described estimates the homography transformation of planar objects by aligning a planar template to the observed image of that template. However, the homography transformation can be augmented with non-linear transformations to model and measure the distortion coefficients in the intrinsic camera parameters, which can be a straightforward process to those familiar with prior camera calibration attempts. The alignment of the input image 12 to the template 14 can be carried out by using the registration parameter estimator 16, which can be a general function approximator such as artificial neural networks, trained using a self-learning mechanism based on unlabeled or labelled data.

The exemplary embodiment described herein estimates homography transformation parameters between color images and full or partial edge maps or a synthetic template of those images, for the application of sports field registration. Given an image 32 and an edge image 34, the homography is estimated using a regression network 36 to generate four-points parameters.

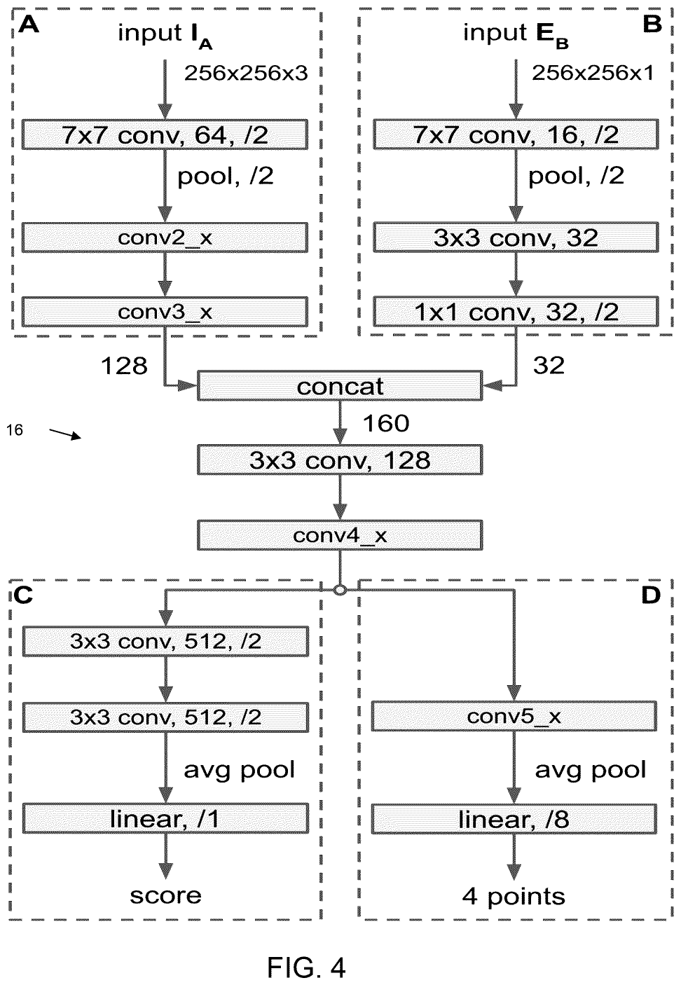

FIG. 4 illustrates an exemplary embodiment for the registration parameter estimator 16, wherein artificial neural networks and four-point parameterization are used for homography estimation. In the exemplary embodiment, two separate non-identical processing streams A and B in the forms of convolutional neural networks are applied to an input image (denoted by I_{A}) and the edge image or template (denoted by E_{B}). The two streams are merged and then split into separate processing streams C and D, wherein stream C generates a four-point parametrization of the input image for homography estimation, and stream D generates a score, a quantitative value measuring the quality of the registration given the estimated parameters for image registration. Any form of function approximation techniques, or neural networks can be used for the processing streams described in FIG. 4. In an exemplary embodiment, residual neural network architecture is used to build the processing streams. The regression network 36 is a combination of streams A, B, and C.

It is noted that the numerals in FIG. 4 refer to parameters transferred between components of the shown registration parameter estimator 16, and do not refer to components with a similar number in FIGS. 1 to 3 and 5 and 6.

The process described in FIG. 4 can be applied on images iteratively, meaning that after generating an estimation for homography, more iterations of the same process can be followed based on the previous estimated registration parameters to reduce the misalignment error. The registration transformation will be a combination of all the estimated registration parameters from all iterations.

For homography estimation, a four-points parameterization can be employed to define the relationship between the input image I_{A} and the template E_{B} through the coordinates of the four control points on the input image I_{A} when warping into the template E_{B}. The four points can be randomly chosen, or preconfigured. By way of example, and with reference to the process illustrated in FIG. 3, four fixed points from the input image 32 can be selected as control points. Assuming the example image 32 has the size of 1280×720 pixels, the four control points can be [(1023,144),(256,144),(1023,575), (256,575)], which are the four corners of a rectangle centered at the center of the image 32 but having a patch size of 768×432. The regression network 36 is trained using labeled or unlabeled data to estimate the corresponding four points in a template (e.g., template 14) or the edge image 34. In example embodiments, at least four points are used for homography estimation, or other linear and non-linear image registration is used to map the points.

To evaluate the quality of the homography estimation in aligning the two images or estimating camera parameters, a quantitative value is generated by a process that takes the image 32 and the template 34 as the inputs. The score regression network, shown in FIG. 4 as a combination of processing streams A, B, and C generates the values quantifying the quality of the estimated registration. The quality of registration can be in any form of reprojection error or intersection-over-union (IoU) of the aligned images. In the exemplary embodiment IoU is estimated by the score regression network.

In another embodiment, the score regression networks can be used to adjust or find the best matching template 34 to the input image 32. When the template 32 or edge map E_{B} has variable features, the score regression network can identify an optimal template or E_{B}. This is achieved by performing registration on the same input image 32 and a variable template or edge map (not shown) that maximizes the registration quality score or minimizes the registration error, resulting in generating a template or an edge map that best correlates to the physical features of the input image. An example application of implementing score regression networks in this manner is estimating unknown soccer pitch dimensions from images of the soccer field for sport field registration, by testing a range of templates and looking for the optimal score.

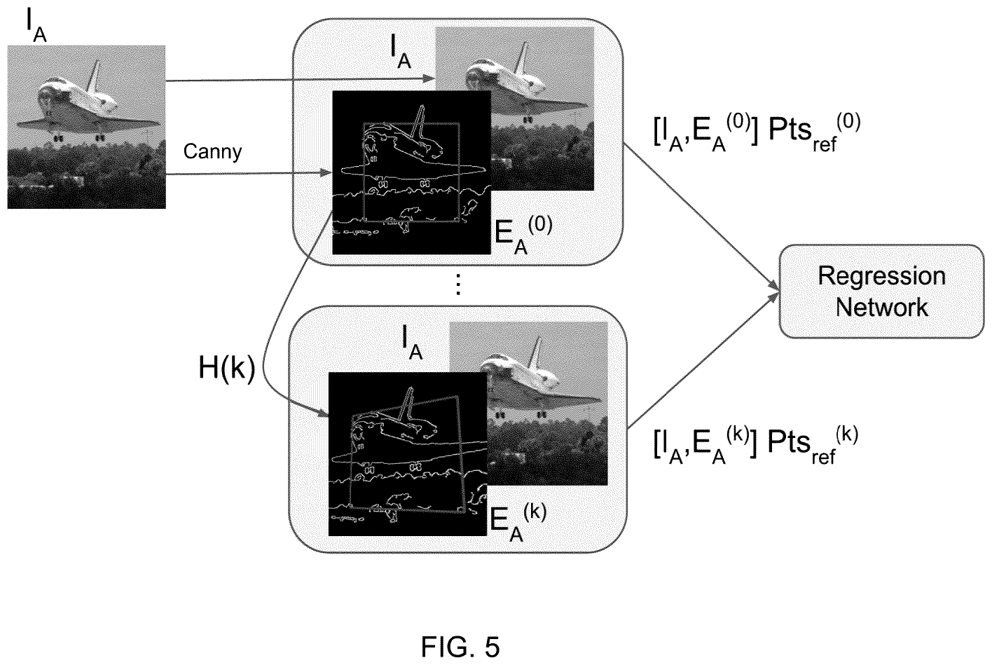

The registration parameter estimator is a function approximator that can be learned using machine learning techniques. In the exemplary embodiment described herein, convolutional neural networks are used as the registration parameter estimator. In the process illustrated in FIG. 5, a self-learning mechanism is employed to generate a registration parameter estimator, or train the regression network. In contrast to the supervised learning techniques, the self-learning mechanism does not need to use a set of labeled images as training data. For homography estimation, the set of labeled images consists of pairs of images and the template 14 with a known homography transform between the two. In the self-learning process, a single image is used, without providing an associated template 14 with a known homography.

In the self-learning mechanism illustrated in FIG. 5, for an image I_{A}, and edge map E_{A}⁽⁰⁾ is generated using known computer vision techniques such as Canny edge detector. The pair of the image and the edge map is used as one of the training samples. In this case it is expected that the registration network to generate four control points on the template corresponding to those in the image, scaled by the registration network input size, Pts_{ref}⁽⁰⁾. To generate more training samples, the control points, Pts_{ref}⁽⁰⁾, are randomly perturbed to generate a new set of points, Pts_{ref}^{(k)}. The relationship between the control points Pts_{ref}⁽⁰⁾ and the perturbed ones Pts_{ref}^{(k)} is governed a homography transformation, H(k). The homography transformation H(k) is then applied to the edge map E_{A}⁽⁰⁾ to generate a perspective transformed edge map, E_{A}^{(k)}.The perturbation process is repeated several times per image to create multiple samples to train the regression network. The perturbation is also performed to simulate camera translation, rotation and focal length changes. Once the data is generated, standard techniques can be applied to train the regression network using Stochastic Gradient Descent or other optimization techniques.

The regression network and score regression network can be trained independently or jointly, or can be merged together in one neural network.

Once the training is done, the obtained registration parameter estimator, in this case the regression network and score regression network, can be applied to an image and a template to generate the desired output. For an iterative process, to improve the quality of the alignment, the process can be applied multiple times on the input. The initial pass estimates the coarse homography between the input image I_{A} and edge map E_{B}. The output homography is used to perform perspective transformation on E_{B}. Then, the warped E_{B} and I_{A} are fed as network input for the next iteration. The process is repeated until the score from the score regression network is higher than a defined threshold or the maximum number of iterations is reached.

This exemplary embodiment uses the artificial neural networks as the registration parameter estimator to simultaneously generate the registration transformation and its parameters and the registration quality score which quantifies the alignment accuracy. The neural networks in the shown embodiments are chosen to be ResNet-18 and ResNet-50 architectures. It may be noted that any other function approximation technique other than neural networks can be used here, and the system 10 is not limited to the use of specific NN architecture.

The iterative process for homography estimation can combine the disclosed method with traditional homography estimation techniques using image feature point detection, wherein the first iteration is carried out by the system 10 and the next iteration uses conventional methods. In this setup, the system 10 provides an initial estimate for homography and acts as the initialization step for homography estimation.

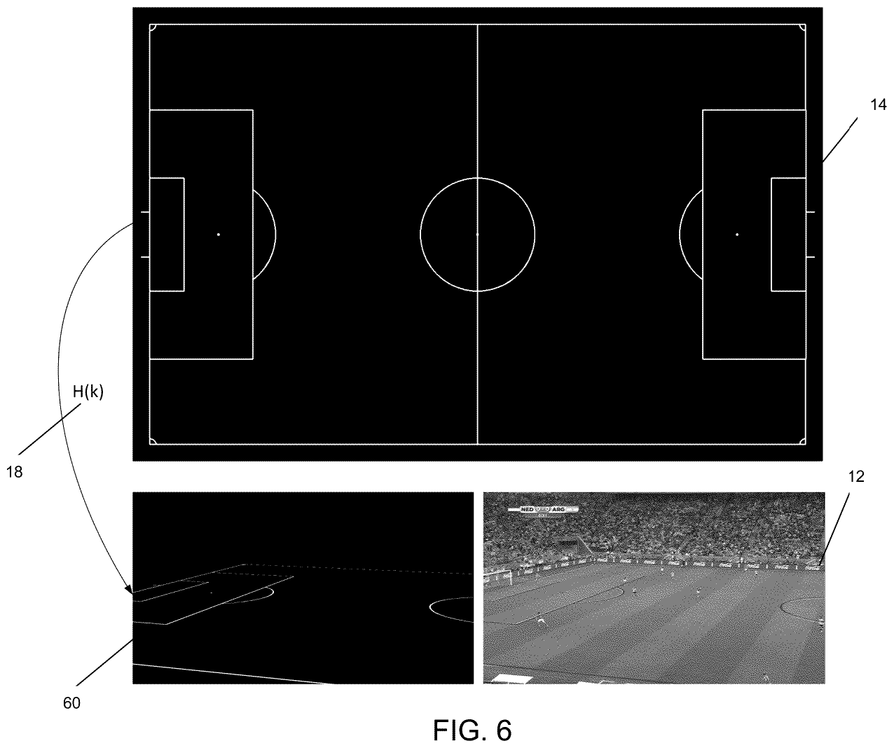

Experimental evaluation of the disclosed method for sports field registration on images of soccer, volleyball and ice hockey was conducted. An example of the results of the testing are shown in FIG. 6. FIG. 6 provides an example of registering sports images to the templates in soccer, using a homography transformation H(k). In FIG. 6, the template 14 is a synthetic image of a soccer field, the input image 12 is an image of a real soccer field extracted from a broadcast feed, and the aligned template to the image 60 is the warped template using the estimated homography transformation 16, obtained as the output of the registration parameter estimator of the system 10.

The datasets used in testing are from the sports field registration literature, including a soccer image dataset, Homayounfar et al. (2017); a volleyball image dataset, Chen and Little (2019); and a hockey image dataset, Homayounfar et al. (2017). The quality of the registrations is measured by calculating the average intersection over union of the warped input image registered to the template. In summary fashion, the results of the testing measured a quality of 96.61% for the soccer database, a quality of 99.71% for the volleyball database, and a quality of 97.99% for the hockey image database. The experimental evaluation clearly shows potential advantages of the disclosed method.

### REFERENCES

Brown, Matthew, and David G. Lowe. “Recognising panoramas.” In ICCV, vol. 3, p. 1218. 2003.
Mur-Artal, Raul, and Juan D. Tardós. “Orb-slam2: An open-source slam system for monocular, stereo, and rgb-d cameras.” IEEE transactions on robotics 33, no. 5 (2017): 1255-1262.
DeTone, Daniel, Tomasz Malisiewicz, and Andrew Rabinovich. “Deep image homography estimation.” In RSS Work-shop on Limits and Potentials of Deep Learning in Robotics, 2016.
Viola, Paul, and William M. Wells III. “Alignment by maximization of mutual information.” International journal of computer vision 24, no. 2 (1997): 137-154.
Homayounfar, Namdar, Sanja Fidler, and Raquel Urtasun. “Sports field localization via deep structured models.” In Proceedings of the IEEE Conference on Computer Vision and Pattern Recognition, pp. 5212-5220. 2017.
Chen, Jianhui, and James J. Little. “Sports camera calibration via synthetic data.” In Proceedings of the IEEE/CVF Conference on Computer Vision and Pattern Recognition Workshops, pp. 0-0. 2019.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

This exemplary embodiment disclosed the use of one single image as the input for the method, but various modifications to make use of a sequence of images instead of one image are possible within the principles discussed herein. For example, one can naturally embed temporal consistency in a sequence of images by reusing the optimization state for consecutive images.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for registering images to each other or registering images to templates to generate geometric or nonlinear registration transformation mappings, the method comprising:
obtaining a first image from an imaging device, wherein the first image is in a first modality;
obtaining either a reference image, or a template, wherein the reference image or the template comprises a partial or full representation of contents of the first image, and wherein the reference image or the template is in a second modality;
applying at least one mapping function to one of the first image, the reference image or template, or both the first image and the reference image or template by mapping pixel data of the template or reference image to the first image to generate an estimation of a parametric registration transformation; and
providing output data comprising one or more parameters of the parametric registration transformation.

2. The method of claim 1, wherein the first and second modalities are different modalities.

3. The method of claim 1, wherein the first and second modalities are the same modality.

4. The method of claim 1, wherein the at least one mapping function comprises a general function approximator, learned using at least one machine learning or artificial intelligence technique trained using images to estimate the one or more parameters of the parametric registration transformation.

5. The method of claim 4, wherein the at least one mapping function is learned using self-learning techniques wherein a set of previously labelled data is not available.

6. The method of claim 5, wherein the self-learning techniques include designating reference points on the template or the reference image, and the mapping function represents the parametric registration transformation using at least the reference points as parameters.

7. The method of claim 6, wherein the reference points include at least four points and are randomly chosen or preconfigured.

8. The method of claim 7, wherein the at least four points are four corners of a rectangle centered at a center of the first image.

9. The method of claim 4, wherein the at least one mapping function is learned using either labeled data or a combination of labeled and unlabeled data.

10. The method of claim 9, wherein the learned mapping function is adjusted using at least one labeled data point, using supervised machine learning techniques.

11. The method of claim 1, further comprising generating a quantitative value measuring a quality of the estimation of the registration transformation.

12. The method of claim 1, further comprising:
initializing another image registration technique for further improving a quality of the estimation of the registration transformation with parameters of the registration transformation.

13. The method of claim 1, further comprising, either: i) adjusting the template or ii) generating the template, wherein the adjusted template results in an optimal or suboptimal registration.

14. The method of claim 1, wherein the registration transformation aligns extrinsic or intrinsic parameters of the imaging device with the first image and is a geometric transformation or a planar homography transformation.

15. The method of claim 1, wherein the registration transformation is used to calibrate the imaging device, and a geometric transformation of the registration transformation represents intrinsic and extrinsic parameters of the imaging device, and a non-linear transformation of the registration transformation comprises optical distortion parameters of the imaging device.

16. The method of claim 1, wherein the first image shows a part of a sports field and the template comprises the shape of the sports field.

17. The method of claim 16, wherein the registration transformation comprises a homography transformation between the first image of the sports field and the template.

18. The method of claim 16, wherein the template is adjusted to account for dimensions of the sport field observed in the first image.

19. The method of claim 16, wherein the imaging device comprises a broadcast camera and the first image is obtained from a sporting event, and wherein the registration transformation maps each pixel in the first image to its corresponding location in the template, wherein the template includes real world coordinates.

20. The method of claim 1, further comprising:
obtaining a third image from the imaging device;
applying the at least one mapping function on the third image or one of the reference image or template, or both the third image and the reference image or template by mapping pixel data of the template or reference image to the third image to generate a further estimation of the parametric registration transformation; and
updating the one or more parameters of the parametric registration transformation based on the further estimation; and
providing output data comprising the updated one or more parameters of the parametric registration transformation.

21. A non-transitory computer readable medium storing computer executable instructions for registering images to each other or registering images to templates to generate geometric or nonlinear registration transformation mappings, comprising instructions for:
obtaining a first image from an imaging device, wherein the first image is in a first modality;
obtaining either a reference image, or a template, wherein the reference image or the template comprises a partial or full representation of contents of the first image, and wherein the reference image or the template is in a second modality;
applying at least one mapping function to one of the first image, the reference image or template, or both the first image and the reference image or template by mapping pixel data of the template or reference image to the first image to generate an estimation of a parametric registration transformation; and
providing output data comprising one or more parameters of the parametric registration transformation.

22. A device comprising a processor, an input interface for obtaining images from an imaging device, and a memory, the memory comprising computer executable instructions that when executed by the processor cause the device to register images to each other or registering images to templates to generate geometric or nonlinear registration transformation mappings, comprising instructions for:
obtaining a first image from an imaging device, wherein the first image is in a first modality;
obtaining either a reference image, or a template, wherein the reference image or the template comprises a partial or full representation of contents of the first image, and wherein the reference image or the template is in a second modality;
applying at least one mapping function to one of the first image, the reference image or template, or both the first image and the reference image or template by mapping pixel data of the template or reference image to the first image to generate an estimation of a parametric registration transformation; and
providing output data comprising one or more parameters of the parametric registration transformation.

23. A method for generating registration transformation mappings, the method comprising:
obtaining a first image from an imaging device, wherein the first image is in a first modality;
generating a second image from the first image, the second image in a second modality;
applying at least one mapping function on of the first image or the second image, or both, by mapping pixel data of the first image to or reference image, or the second image, to the first image to generate an estimation of a parametric registration transformation; and
providing output data comprising one or more parameters of the registration transformation mapping.
